(19) United States
(12) Patent Application Publication
(10) Pub. No.: US 2025/0004700 A1
(43) Pub. Date: Jan. 2, 2025

(54) CONTEXTUAL MEDIA CONTENT RECOMMENDATIONS

(71) Applicant: Sonos, Inc., Goleta, CA (US)

(72) Inventors: Sein WOO, Coromar, CA (US); Ryan MYERS, Coromar, CA (US); Konstantin VOVK, Coromar, CA (US)

(21) Appl. No.: 18/754,022

(22) Filed: Jun. 25, 2024

Related U.S. Application Data
(60) Provisional application No. 63/523,752, filed on Jun. 28, 2023.

(51) Int. Cl. G06F 3/16

(52) U.S. Cl. CPC G06F 3/165

(57) ABSTRACT

Methods for providing contextual media content recommendations are disclosed. The media content recommendations are based on a playback history comprising media items previously played back and based on a playback context. The playback context can be a personal context, in which media content is provided to the user alone, or a shared context, in which media content is provided to the user in presence of at least one additional user. For the personal context, the media content recommendations are based on a first set of media items in the playback history. For the shared context, the media content recommendations are based on a second set of media items in the playback history. The second set of media items excludes at least one media item included in the first set of media items.

### CROSS-REFERENCE TO RELATED APPLICATIONS

This application claims the benefit of and priority to U.S. Provisional Patent Application Ser. No. 63/523,752 filed on Jun. 28, 2023 and entitled “CONTEXTUAL MEDIA CONTENT RECOMMENDATIONS,” which application is expressly incorporated herein by reference in its entirety.

### FIELD OF DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 2 illustrates a flowchart for a set of methods of providing contextual context recommendations, in accordance with some embodiments described herein.

FIG. 3 illustrates an example playback environment and example elements that could be involved in the execution of one or more blocks of the methods in FIG. 2, in accordance with some embodiments described herein.

FIG. 4 includes a flowchart for a set of methods of associating media content based on context, in accordance with some embodiments described herein.

FIG. 5 illustrates a flowchart for a set of methods of providing media content for playback according to the playback context, in accordance with some embodiments described herein.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Privacy has become an important concern in almost every area of information technology. When it comes to media playback, some users may prefer to keep their media playback activity (e.g., listening activity, viewing activity, etc.), or at least part of it, private. On the other hand, most users benefit from media content recommendations offered by content providers (e.g., streaming services). However, media content recommendation algorithms often require some knowledge about the user's playback activity in order to provide convenient and useful content recommendations. Reconciling these interests continues to be a challenge.

Some users may desire to keep their media playback activity private so that their playback history and/or preferences, at least in some instances, is not revealed to other users. For example, some users may enjoy a certain kind of content, but may prefer not to share their liking of such type of content with other users. Furthermore, a person's behavior can vary when the person is alone versus when the person is in an environment with more people. In this way, media content that a user consumes when the user is playing back content alone (e.g., in a solo, personal, or private playback session) may be different from media content that the user prefers to consume when the user is playing back content while other people are around. In these cases, users may desire that some of the content they play back (e.g., listen to, watch, etc.) in personal playback sessions does not influence the content that is played back and/or the content recommendations they get when they are not alone. However, the user may still benefit from content recommendations for personal playback sessions related to the content that the user consumes when playing back content alone.

Furthermore, the content that a user consumes when alone may not be suitable when other users are present and/or exposed to the media content. For example, a parent may enjoy consuming certain kinds of content that may not be appropriate for kids (e.g., songs that include explicit content, artists or other content creators who use profanity, crime TV shows that show disturbing images, etc.). The parent may take advantage of content recommendations associated with this type of content when the parent is alone. However, the parent may wish to avoid such type of content from being recommended and/or played back when they are with their kids.

Some solutions to the issues above involve the use of a private playback mode in which playback activity and/or media content played back is not tracked and/or shared with other users. These private playback modes often operate as the “incognito” mode in a browser. However, these types of private playback modes often affect the user's content recommendation in that the content they play back while in the private playback mode may not be considered by recommendation algorithms at all. These solutions may not always be advantageous because a user may still like to have the content they play back in a private playback mode considered for private recommendation purposes.

Other solutions involve the manual removal of certain playback activity. For example, a user may have the option to remove certain media content from their playback history or preferences profile. However, similar to the solutions above, altering the playback activity to remove content that the user plays back when they are alone can often affect the user's content recommendation in that this content may not be considered by recommendations algorithms at all. Additionally, these solutions often require an explicit indication of the specific content to be removed (e.g., a song or playlist), and are not designed for dynamic or unexpected reproduction of media content that has otherwise not been “flagged” by the user.

As mentioned and illustrated in the examples above, maintaining user privacy while at the same time providing valuable content recommendations continues to be a challenge. Solutions described in this disclosure involve curating content and/or content recommendations based on context determination. More specifically, some solutions described herein involve a differentiation between a personal/private context in which a user alone is exposed to the media content, and a public/shared context in which at least one additional user might be exposed to the media content. According to some solutions, the media playback experience can be adapted depending on the context, so that media content recommendations are appropriate for the type of context the user is in.

Generally, media content recommendations can be based on the user's playback history (e.g., previous playback activity, media items that the user has played back before, media items for which the user has indicated certain preference before, etc.). In accordance with some examples described herein, media content recommendations can additionally or alternatively be adapted to the current playback context. For example, when a user is in a private context, media content recommendations can be based on a particular portion (e.g., a particular set of media items) of the user's playback history. Alternatively, when a user is in a shared context, media content recommendations can be based on a different portion (e.g., a different set of media items) of the user's playback history. Media content recommendations can be “based on” one or more media items in that the one or more media items can be used as a seed, reference and/or sample for a recommendation system to provide similar and/or related media content, as will be explained below in more detail.

The sets of media items used as reference for the content recommendations to be provided in the private and the shared contexts can differ in at least one aspect. These sets of media items can be completely different or partially different (e.g., have some similarities/overlap). For example, media content recommendations for a private context can be based on a portion of the playback history while media content recommendations for a public context can be based on another portion of the playback history. As another example, media content recommendations for a private context can be based on the whole playback history while media content recommendations for a public context can be based on only part of the playback history. In any case, part of the playback history can remain private and be available to the user alone. At the same time, this private part of the playback history can still be used as a reference for content recommendations when the user is playing back media content alone (i.e., in a private context).

The solutions provided in this disclosure can be advantageous in that they allow the possibility of keeping at least part of the user's playback activity private while at the same time still keeping track and/or considering such part of the playback activity for other purposes such as content recommendations when appropriate (e.g., in private contexts). Furthermore, in some instances, the determination of the type of playback context can be made without requiring explicit user input based on various factors, as will be explained below in more detail. In this way, content recommendations can be adjusted automatically based on the determined context.

In some embodiments, for example, a computing system is provided. The computing system comprises at least one processor and at least one non-transitory computer-readable medium comprising program instructions that are executable by the at least one processor. The computing system may determine a context in which media content is to be played back by a user of a media playback service account, wherein the context comprises one of: (i) a personal context in which media content is provided to the user alone; or (ii) a shared context in which media content is provided to the user in presence of at least one additional user. The computing system may also provide at least one media content recommendation based on the determined context and based on a playback history comprising media items previously played back via the media playback service account; wherein: for the personal context, the at least one media content recommendation is based on a first set of media items in the playback history; and for the shared context, the at least one media content recommendation is based on a second set of media items in the playback history, wherein the second set of media items excludes at least one media item included in the first set of media items.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

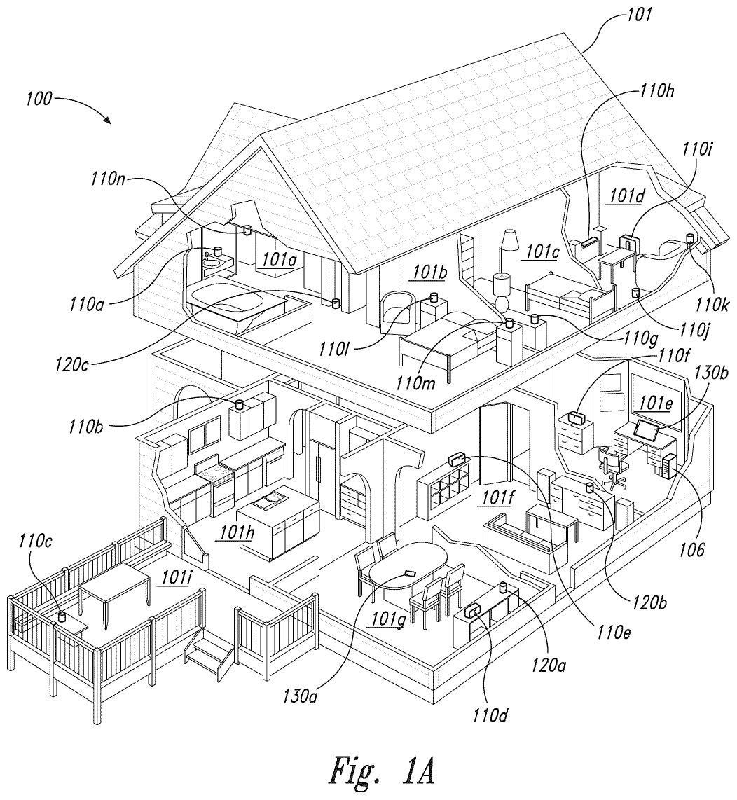

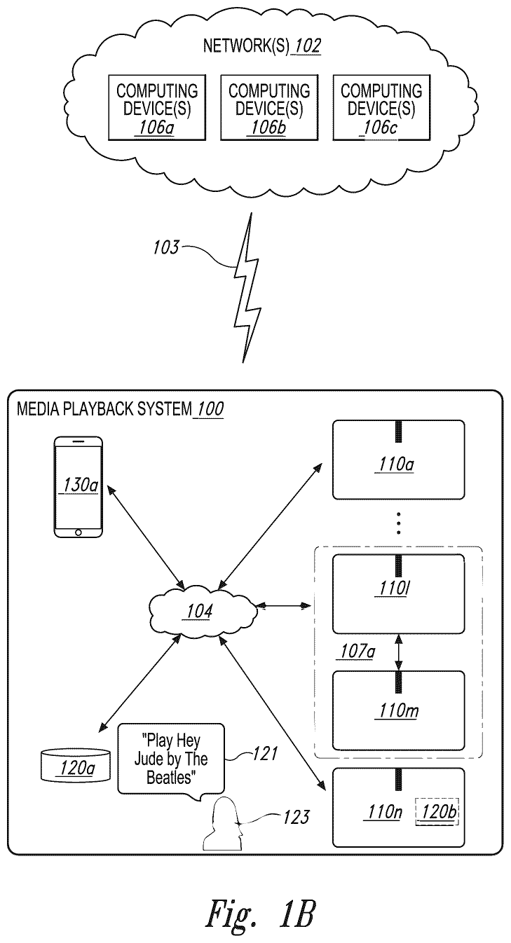

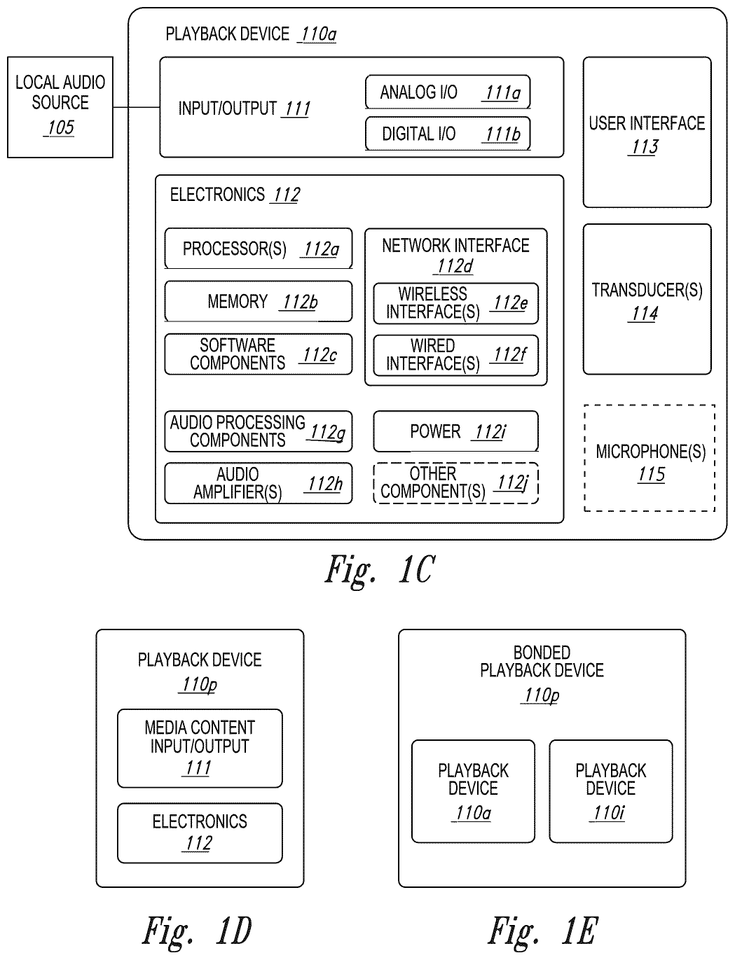

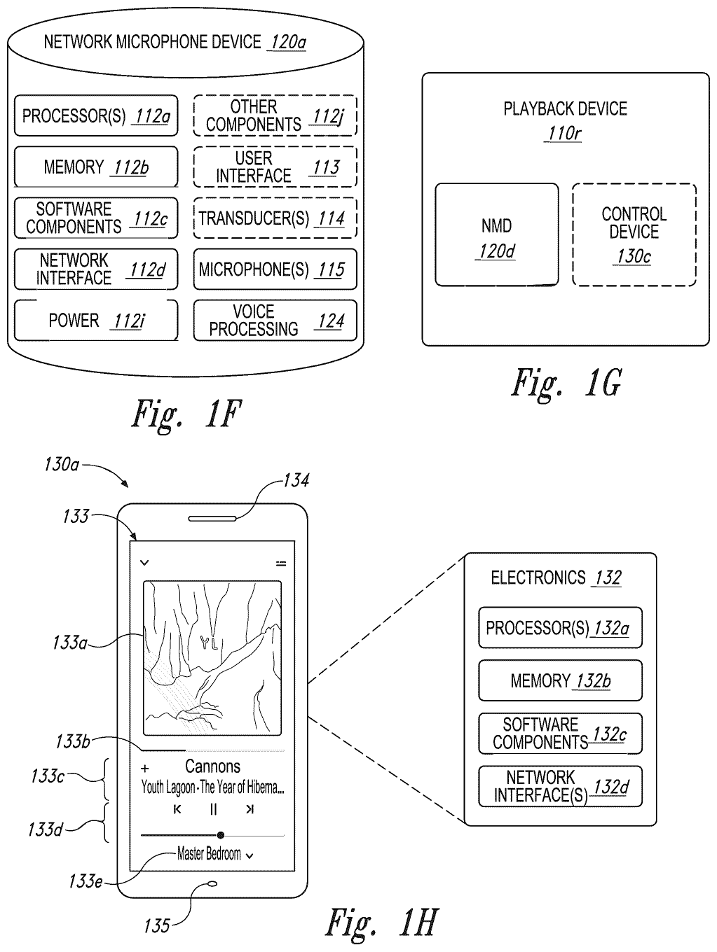

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 1101 and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOGGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Contextual Media Content Recommendations

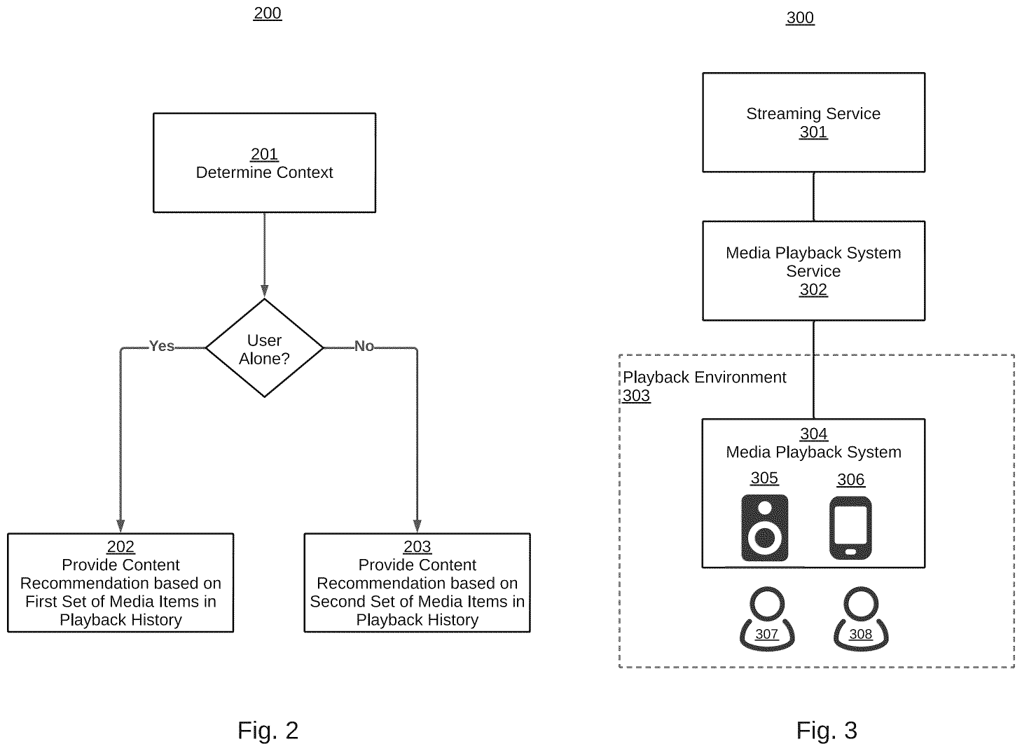

FIG. 2 illustrates a flowchart 200 for a set of methods of providing contextual context recommendations, in accordance with some embodiments described herein. The method in FIG. 2 can be executed to provide passive recommendations to the user. For example, the method can be executed when the user opens an application to play back content, in order to provide content recommendations consistent with the current context. The method can then continue to be performed at intervals and/or when a change in context is detected so that the content recommendations continue to be accurate. The method could also or alternatively be executed in response to a user input such as when the user requests a media content recommendation and/or starts playback.

Flowchart 200 includes a first block 201 of determining a context in which media content is to be played back by a user. As mentioned before in this disclosure, the context can comprise a personal/private context in which media content is provided to the user alone and/or the user alone is exposed to the media content, or a shared/public context in which media content is provided to the user in presence of at least one additional user and/or the at least one other user might be exposed to the media content.

Flowchart 200 includes blocks 202 and 203 of providing at least one media content recommendation. The media content recommendation provided in blocks 202 and/or 203 can be based on a playback history and/or the context determined in block 201. As indicated in block 202, for a first context (e.g., a personal context), the at least one media content recommendation can be based on a first set of media items in the playback history. As indicated in block 203, for a second context (e.g., the shared context), the at least one media content recommendation can be based on a second set of media items in the playback history.

As mentioned before and as will be explained below in more detail, the first and second sets of media items can differ in at least one aspect. For example, the first and second sets of media items can include one or more different media items. As another example, the second set of media items (for a shared context) can exclude at least one media item included in the first set of media items (for a private context). In this way, at least part of the playback history remains available to the user alone.

The different blocks in flowchart 200, as described, can be conducted by one or more computing systems comprising one or more computing devices (e.g., cloud computing systems, servers, user devices, playback devices, smart devices). The computing systems and/or devices can comprise at least one processor and at least one non-transitory computer-readable medium collectively comprising program instructions that are executable by the at least one processor such that the computing system(s)/device(s) are configured to execute the flowchart blocks.

FIG. 3 illustrates an example playback environment 303 and includes some elements that could be involved in the execution of one or more blocks of flowchart 200. The playback environment can be an environment (e.g., location, space, room, etc.) where media content could be played back by a user. In some instances, a playback environment such as playback environment 303 could be defined as the space where media content played back could be perceived (e.g., heard and/or seen) by users. In other words, users (e.g., user 307 and/or user 308) in playback environment 303 could be “exposed” to media content played back in such playback environment.

The playback environment can comprise a media playback system 304 comprising one or more playback devices 305. The media playback system 304 can be the same or similar to the media playback system 100 described with reference to FIGS. 1A-1H Similarly, the playback device(s) 305 can be any of the playback devices 110/120 described with reference to FIGS. 1A-1H. The playback device(s) 305 can include any device capable of playing back media content, such as loudspeakers, TVs, headphones, computers, phones, etc. The playback environment can comprise one or more user devices 306. The user device(s) 306 can be any of the control devices 130 described with reference to FIGS. 1A-1H or other user devices. In some instances, the user device(s) 306 can be a playback device as used in this disclosure and/or be part of the media playback system 304. For example, the user can play back media content (watch/listen) via their phone or personal computer.

A user, such as user 307, and/or their media playback system could be associated with (e.g., subscribed, signed up, registered with) one or more media playback services and/or corresponding media playback accounts. The media playback service(s)/account(s) can comprise a media playback system service/account. For example, the user could have an account with a media playback system service 302 associated with their media playback system 304. The media playback system service could include a service provided by a media playback system provider such as Sonos Inc. The media playback service(s)/account(s) can additionally or alternatively comprise one or more streaming service(s)/account(s). For example, the user and/or their media playback system could be associated with (e.g., subscribed, signed up, registered with) one or more streaming services 301.

In some instances, the user could be associated with a service that acts as an intermediary and/or aggregator between the user and other services the user has access to. Service 302 could be an example intermediary service. Different services such as different streaming services 301 could be associated with this intermediary service so that the user has centralized access via the intermediary service. For example, the user could associate/integrate their streaming service accounts with their media playback system account so that content from the different streaming services can be accessed, played back, and/or recommended via the media playback system service. Examples of how to create this association are described in U.S. Pat. No. 8,910,265, filed Sep. 28, 2012, entitled: “Assisted Registration of Audio Sources”, which is incorporated herein by reference in its entirety.

Any one or more of the blocks in flowchart 200 could be performed by one or more of a streaming service such as streaming service 301 (e.g., by a computing system associated with the service), and/or an intermediary service such as media playback system service 302 (e.g., by a computing system associated with the service), and/or by one or more devices in the playback environment 303 such as devices of the media playback system 304 (e.g., playback device 305 and/or a user device 306).

### Context Determination:

Block 201 of flowchart 201 of determining the context can include receiving an input from the user and determining the context based on the input. For example, a user could select, via a user interface displayed on a user device, a type of context. The user could be prompted to select a context when the user initiates (or is about to initiate) a playback session. For example, a prompt to enter context data (e.g., select between personal or shared contexts) could be displayed when the user opens an application to play back media content and/or when the user selects media content for playback.

Block 201 of flowchart 201 of determining the context could also or alternatively include receiving context data from the playback environment 303 and determining (e.g., inferring) a type of context from the context data. Context can be determined directly from the context data (e.g., the context data may include indications that the user is alone). In some instances, context can be determined from indications in the context data that map to reference data indicative of specific contexts (e.g., reference data stored in memory). For example, context data may indicate that the user is listening to music in the bedroom at 7 pm. One or more of these indications could be associated with a private context based on data previously provided. Context could also be determined by providing the context data to an algorithm trained to infer a context from the context data. In some instances, when context information is absent (e.g., cannot be obtained), the system can default to a shared context to prevent private content from being inadvertently exposed to other users.

Different mechanisms/means for obtaining context data will be described below. Regardless of how context data is obtained, block 201 could be performed by any one or more of the devices in playback environment 303, and/or by any computing system/device associated with a media playback service such as services 301 and/or 302. For example, context data could be obtained by the media playback system 304 and sent to service 302 or 301 for execution of block 201.

Context data can include user's presence detection data. This type of context data can be obtained by detecting a presence of one or more users (e.g., users 307 and/or 308) within a proximity of at least one device via which media content is to be played back (e.g., within playback environment 303). User(s) presence detection can be performed via any presence detection mechanism/means. Presence detection means can include sensors (e.g., proximity, presence, optical, sonic, magnetic or any other type of sensor) located in the playback environment. Presence detection means can also or alternatively include microphones in the playback environment that could capture sounds and determine presence of users in a proximity (e.g., in the acoustic space). Detecting the presence of one or more users could include detecting voices and/or voice signatures. The voices/voice signatures could indicate how many users (and even which users in some instances) are in the environment or the acoustic space of the device capturing the voice. Example techniques for user presence detection based on voice detection are described in U.S. Pat. No. 9,084,058, filed Dec. 23, 2011, entitled “Sound Field Calibration Using Listener Localization”; U.S. Pat. No. 9,285,886, filed Jun. 24, 2013, entitled “Intelligent Amplifier Activation”; and U.S. Pat. No. 10,095,470, filed Aug. 15, 2016, entitled “Audio Response Playback”, all of which are incorporated by reference herein in their entirety.

In some instances, presence detection means are provided with, embedded in, located in or near the media playback system to be used for media playback (e.g., the media playback system 304). For example, microphones of one or more playback devices could be used for presence detection purposes. These microphones could be dedicated for this purpose, or serve other purposes as well such as calibration, voice detection for voice inputs and control, etc. Presence detection means can also or alternatively be located anywhere in, near or around the playback environment and not necessarily be sensors of a playback device to be used for playback. For example, any smart device in a home (e.g., a security camera, a smart light, etc.) could detect and communicate presence detection information that can be used for context determination in block 201.

Presence detection information can be captured by one or more presence detection means and sent to a computing device/system for context determination. In this sense, block 201 could include one or more of detecting the presence of the user(s) and/or receiving the presence detection data captured by the one or more presence detection means. For example, block 201 could be conducted by one or more devices of the media playback system that detect user's presence and send the presence detection information to a processor in the media playback system (e.g., a processor of one of the devices in the media playback system) to derive the context therefrom (e.g., to determine how many users are present in the playback context). Alternatively, the presence detection information could be captured by the presence detection means and sent to/received by a remote computing system (e.g., a computing system associated with the media playback system service 302, a computing system associated with a curation or streaming service 301, etc.) for performing context determination.

Other example presence detection and/or context detection mechanisms are described in U.S. Pat. No. 9,195,432, filed Feb. 26, 2013, entitled “Pre-Caching of Audio Content”, U.S. Pat. No. 9,478,247, filed Apr. 28, 2014, entitled “Management of Media Content Playback”, all of which are incorporated by reference herein in their entirety.

Context data could additionally or alternatively include device's presence detection data. This type of context data can be obtained by detecting a presence of one or more user devices (e.g., user device 306) within a proximity of at least one device via which media content is to be played back. For example, if it is detected that two different user devices belonging to different users (e.g., two smartphones) are in the playback environment, it could be inferred that two users could potentially be around the playback environment. Device presence detection can be performed via any presence detection mechanism/means such as any of the presence detection mechanisms/means described above for user presence detection. Furthermore, different devices could advertise their presence (e.g., via a broadcast signal) so that presence detection means could receive the advertisement signal and determine the device's presence. Devices could also communicate via various communication protocols (e.g., BLUETOOTH, WIFI, NFC, etc.) so that the presence of a user device is noted. In some instances, devices can communicate via sound cues (e.g., ultrasound tones). The signals received from the different devices could include data (e.g., a device identifier) identifying the devices so that it may be possible to determine which devices (e.g., from which users) are in the playback environment.

Other example presence detection and/or context detection mechanisms are described in PCT App. No. PCT/US2022/070705, filed Feb. 17, 2022, entitled “Wireless Streaming of Audio-Visual Content and Systems and Methods for Multi-Display User Interactions”, and U.S. Pat. App. Pub. No. 2022/0286795, filed Mar. 8, 2022, entitled “Operation Modes, Audio Layering, and Dedicated Controls for Targeted Audio Experiences”, all of which are incorporated by reference herein in their entirety.

Context data could also or alternatively include a characteristic of one or more devices via which media content is to be played back. This type of context data can be obtained by determining a characteristic of the one or more devices directly from the devices themselves or via other means. The characteristic can include any one or more characteristics of the playback device such as a type of device, a name of the device, a status of the device, a preference designated for the playback device, etc.

For example, certain types of devices such as headphones, virtual reality headsets or personal computers could be associated with a personal playback experience/context in that it may be expected that the user alone is going to be exposed to the media content played back. Other types of devices such as loudspeakers or TVs could be associated with a shared playback experience/context in that more users could be exposed to the media content played back. As another example, a device name could also be used to indicate a personal or a shared context. For example, if a playback device name is “John's earbuds”, it is expected that John will be using the earbuds. However, if a playback device name is “living room TV”, it may be expected that more users may watch the TV.

The differentiation by type and/or name of device could be standard and/or predefined (e.g., wearable devices are associated with personal contexts and non-wearables devices are associated with shared contexts). Alternatively, preferences for contexts to be associated with the devices could be customizable by the user. For example, the user could set a particular device (e.g., their bedroom's TV) as a device associated with a personal context. The user could set context preferences for their devices/environments at any given time such as during an onboarding process when playback devices are added to the playback environment (e.g., the user's home).

A status of the playback device can also be considered for context determination. For example, a status of the playback device (e.g., in a status report message, in a state variable, etc.) can include an indication of whether the playback device is grouped with other playback devices. A bedroom playback device that may otherwise be associated with a personal context may alternatively be associated with a shared context if grouped with another playback device (e.g., a playback device associated with a shared context) according to the playback device status. As another example, the status of the playback device can include an indication of whether the playback device is at its usual location (e.g., docked in the user's home/bedroom where the context may be private) or at another location (e.g., outside in the patio where the context may be public).

Context data could also or alternatively include a characteristic of at least one room in which media content is to be played back. This type of context data can be obtained by determining the characteristic from devices in the room or data previously received from the room. The characteristic can include any one or more characteristic of the room such as a type of room, a name of the room, a preference designated for the room, etc. For example, if a room name is “bedroom”, it could be associated with a personal context, and if the room name is “patio” it could be associated with a shared context. The preferences for each room could be predefined (e.g., all rooms are associated with shared context unless otherwise specified by the user) or customized by the user. For example, the user could associate a context with each room in their house at any time such as when rooms are created, or when playback devices are added to/associated with those rooms.

Other example context detection mechanisms based on room characteristic are described in U.S. Pat. No. 9,665,339, filed December 2812011, entitled “Methods and Systems to Select an Audio Track”, U.S. Pat. No. 9,672,213, filed Jun. 10, 2014, entitled “Providing Media Items from Playback History”, U.S. Pat. No. 9,226,072, filed Feb. 21, 2014, entitled “Media Content Based on Playback Zone Awareness”, all of which are incorporated by reference herein in their entirety.

Context data could also or alternatively include data indicating an activity that the user is performing or about to perform. This type of context data can be obtained by determining/detecting the activity based on user input, routines, schedule, based on the type of playback device being used (e.g., using the car sound system may indicate the user will be driving), based on information provided by other devices (e.g., devices such as a fitness tracker may indicate that the user is running). Certain activities can be associated with different contexts. For example, running could be an individual activity associated with a personal context. Driving to work could also be an individual activity. Driving kids to school, however, could be associated with a shared context. This determination could be made based on a user's schedule or routines determined by the system and/or set by the user. This determination could also be made based on the user's manual selection of a quick start user interface option for “kids to school morning drive”.

Context data could also or alternatively include any other contextual information such as one or more of: a date, a day of the week, a time of the day or of the year, a location, a user schedule, etc. For example, context data could indicate that the user is usually not alone in the mornings or on weekends. In this way, shared context could be associated with those times. However, contextual data could indicate that the user goes for a walk alone every day in the evening. A personal context could be associated with that time.

As mentioned, using the context data received from the playback environment in any of the forms described above or any other way, a context can be determined in block 201 of flowchart 200. This context differentiation may be relevant in multiple scenarios. For example, in a commercial setting, a user alone (e.g., business owner or employee) may play back any music they'd like outside of commercial hours of operation. However, during commercial hours where more users (e.g., customers) may be exposed to the media content, only commercially available content should be played back. Differentiating between a personal and a shared context in this type of scenario may be not only advantageous but necessary.

Context determination, however, may not be trivial in certain scenarios. For example, in some instances, context determination can include determining whether the media content is going to be provided to the user alone and/or whether the user alone is exposed to the media content, regardless of whether the user is actually alone. For example, a user may be wearing headphones listening to music around other people, and therefore only the user is exposed to the media content even though the user is not alone. This scenario could be associated with a private context.

However, if the user is wearing headphones watching TV, audible content may be provided to the user alone, but other users in the environment may be exposed to the visual content. This scenario could therefore be associated with a shared context if other users are exposed to the visual content, or with a private context if the user is actually alone. Therefore, in some instances, context determination needs to take into consideration several aspects of the context and/or type of content to be played back in order to provide an appropriate context inference.

As another example, if a user selects a quick start option for “dinner” music, the content played back could be curated based on the determination of whether the user is alone or not (maybe the user enjoys listening to classical music while having dinner alone but the user's family does not enjoy classic music as much). In this example, two aspects of the context can be taken into consideration for providing media content recommendations. One is an activity that the user is about to perform (dinner) determined based on a user input, and the other is that the user is alone/not alone, determined in any of the ways described herein. Therefore, multiple combinations of contextual data could be used in order to provide accurate content recommendations.

Other examples for providing media content based on context are described in U.S. Pat. No. 9,338,514, filed Mar. 28, 2014, entitled “Account Aware Media Preferences”, U.S. Pat. No. 9,524,338, filed Apr. 28, 2014, entitled “Playback of Media Content According to Media Preferences”, U.S. Pat. No. 9,680,960, filed Apr. 28, 2014, entitled “Receiving Media Content Based on Media Preferences of Multiple Users”, U.S. Pat. No. 11,393,478, filed Dec. 10, 2019, entitled “User Specific Context Switching”, all of which are incorporated by reference herein in their entirety.

### Providing Media Content Recommendations:

Media content recommendations can be provided in various ways (e.g., blocks 202 and 203 of flowchart 200). In some instances, providing media content recommendations can comprise playing back one or more media items corresponding to the media content recommendation. For example, providing the media content recommendation can comprise causing one or more playback devices to play back a media item corresponding to the recommendation, causing the media item to be added to a playback queue of one or more devices. In some other instances, providing media content recommendations can comprise providing an indication of the media content recommendation(s) via a user interface, rather than actually playing back the media content recommendation. For example, the media content recommendation(s) can be provided by displaying, via a graphical display, graphical representation(s) corresponding to the at least one media content recommendation. The user could then provide a selection via the graphical representation to start playback of the recommended media content.

In some instances, media content recommendations are provided passively to the user (i.e., without any action from the user requesting the recommendations). For example, media content recommendations could be provided so that they are available to the user when they open a media playback application (e.g., a media playback system application, a streaming service application, etc.).

In other instances, media content recommendations can be provided upon request. For example, the user could give an input to start media content playback (e.g., press a “play” button or give a voice command) The media content recommendations can be provided based on the playback request. Example methods for providing playback content based on playback request are described in U.S. Pat. No. 9.298.415, filed Jul. 9, 2013, entitled “Systems and Methods to Provide Play/Pause Content”, which is incorporated by reference herein in its entirety.

In some instances, media content recommendations can be provided to the user based on a trigger. For example, media content could be recommended and/or added to a playback queue after a determination that the queue is empty. The user may have started playback of a specific media content (e.g., a song or a playlist). After the end of the media content started by the user, playback could be automatically extended with the media content recommendations. Mechanisms to automatically extend playback are described in U.S. Pat. No. 9,137,564, filed Jun. 28, 2012, entitled “Shift to Corresponding Media in a Playback Queue”, which is incorporated by reference herein in its entirety.

### Contextual Media Content Recommendations:

As mentioned, the content recommendations provided in blocks 202 and/or 204 can be based on a playback history of media items previously played back by the user. In some instances, the playback history can include media items previously played back by the user via the media playback system 304 and/or any playback device such as playback device 305. In this sense, the media playback history could comprise media items from any media content source (e.g., from multiple streaming services). The media playback history could be maintained (e.g., generated, stored, updated) by the media playback system itself and/or a service associated with it such as service 302. In some instances, the media playback history can be maintained by and/or be specific to a content provider or service, for example, media items played back via a particular streaming service 301. In some instances, the media playback history can be maintained by an intermediary service such as media playback system service 302 so that media items played back from any content source associated with the media playback system service (e.g., any streaming service 301) can be considered in the media playback history.

The service that maintains the payback history may or may not be the service that provides the content recommendations. For example, the playback history may be maintained by a separate service and/or separate database and accessed to provide media content recommendations. In some instances, an intermediary service such as service 302 could access the playback history from independent services such as service 301 and aggregate the playback history from the different services so that content recommendations can be provided based on a comprehensive playback history of media items that the user has played back across multiple services.

As mentioned before in this disclosure, media content recommendations provided for a shared context can be different, at least in some aspects and/or on some occasions, than media content recommendations provided for a private context. In some instances, media content recommendations provided for a shared context can exclude (e.g., disregard or not consider in recommendation algorithms) at least part of the playback history. For example, media content recommendations provided for a private context can be based on a particular set of media items in the user's playback history (e.g., the whole playback history), and media content recommendations provided for a shared context can be based on a different set of media items in the user's playback history (e.g., a subset of the whole playback history). In this way, media content recommendations for shared contexts can be based on a set of media items that exclude one or more media items in the playback history. For example, media content recommendations for a shared context can be based on media items in the playback history that are appropriate for a shared context but exclude other media items that the user may not wish to share publicly or that may not be appropriate for a shared context.

In some instances, media content recommendations for a shared context can be based on a set of media items that excludes at least one media item that could be otherwise included in the set of media items used for media content recommendations for a private context. For example, media content recommendations for a shared context can be based on only a subset of media items in the playback history that the user may not enjoy playing back on their own (e.g., content that their family members like).

In some instances, there can be some overlap between the set of media items used as reference for private content recommendations and for shared content recommendations. For example, there could be types of media content that the user enjoys and/or are appropriate for any scenario/context. The user may prefer to keep a part of their playback history for private contexts but enjoy the other part of the playback history in either private or shared contexts. In this sense, there could be instances in which media content recommendations for private contexts can be the same or similar to media content recommendations for shared contexts, in that they can be based on a set of media items that comprises media items used as a reference for shared content recommendations as well.

In some instances, one or more preferences profiles could be maintained (e.g., generated and/or stored) by any of the media playback services for the user/user account. Preferences profiles can be generated based on the user's playback activity and history. In some instances, the preferences profiles are updated based on explicit user input such a “like” or other explicit preference received from the user for specific media content. In other instances, the preferences profile is updated based on implicit user input (e.g., if the user plays a song multiple times, it may be an indication that the user liked the song, but if the user skips the song multiple times, it may be an indication that the user does not like the song, at least not for the current context).

In some instances, different preferences profiles (or different instances of the preferences profile) can be maintained in association with different contexts. For example, a first preferences profile corresponding to a private context (e.g., a private preferences profile) and a second preferences profile corresponding to a shared context (e.g., a public preferences profile) can be maintained. In this way, depending on the determined playback context (e.g., after execution of block 201 in flowchart 200) the corresponding preferences profile can be selected and/or used for recommendation purposes. In a similar way as described for content recommendations for private and shared contexts, different preferences profiles can be associated with/based on different sets of media items in the playback history. The preferences profiles can be maintained by the same or different service that provides the content recommendations (e.g., the media playback system, any of services 301 and/or 301, etc.).

The preferences profiles can be dynamically and continuously updated based on the media content that the user plays back in each context. For example, if it is determined that the user enjoys a particular type of media content when the user is alone, the private preferences profile could be updated to reflect this preference. In some instances, upon context determination in block 201 of flowchart 200, any media content played back by the user could be associated with the particular context and used for subsequent content recommendations for the particular context. For example, the private preferences profile could be based on a set of media items in the playback history that the user has played back while in a private context. Similarly, the public preferences profile could be based on a set of media items in the playback history that the user has played back while in a shared context.

In some instances, different playback modes could be associated with different contexts. For example, a first playback mode corresponding to a private context (e.g., a private playback mode) and a second playback mode corresponding to the shared context (e.g., a shared playback mode) could be provided. Each playback mode could be associated with different content recommendations and/or corresponding sets of media items in the playback history. The playback modes could be available to the user via their media playback system, streaming services or other service.

The playback modes could be triggered manually by the user (e.g., via a user interface) or automatically upon context determination. In some instances, upon the context determination in block 201 of flowchart 200, the media playback system could be set to the corresponding playback mode for the detected context. Block 201 could be continuously performed or performed at given intervals so that context is constantly assessed. The playback mode could then change automatically if a context change is detected. For example, the user may be listening to music alone (i.e., in a private context) at a first time. At any time after the first time, another user could enter the playback/acoustic space of the user. Context determination as performed in block 201 could be used to determine the presence of the second user and switch playback mode to a shared playback mode so that content is played back and/or recommended accordingly. In some instances, if the content currently being played back is content corresponding to a private context but not to a shared context, playback of such content could be immediately stopped and/or changed to a different type of content suitable for the new context.

As mentioned before, there can be instances in which at least part of the playback history could be used for content recommendations for both the private and the shared context. For example, there can be certain kinds of content that the user enjoys regardless of whether there are other users around, and/or content that the user consumes in any context. In some instances, at least part of the playback history used to provide content recommendations in one context could also be used to provide context recommendations in another context with different levels of impact, relevance and/or different weights on the recommendation algorithms. For example, at least part of the playback history used to generate content recommendations for the public context may have a discounted weight applied when/if used for private context recommendations. In this way, the private context recommendations could still be somehow influenced by the shared context playback history, but not as strongly as the shared context recommendations themselves.

In some instances, there can be different instances, and/or tiers of context. For example, a private context could include an instance/tier where the user is alone and another instance/tier where the user is with other users “authorized” for this type of private context, such as their family members and/or close friends Similarly, a shared context could include an instance/tier in which the user is with family members and/or close friends and another instance/tier in which the user is in a more public playback environment, such as in a party or at the beach with a portable speaker. Content recommendations for each tier of context could be provided accordingly.

In some instances, the tiers can be given by the specific users (or type of users) that might be around the playback session. For example, an example context tier could be associated with a playback session for the user alone; another example context tier could be associated with a playback session for the user in presence of other adults in their household (e.g., their partner); another example context tier could be associated with a playback session for the user in presence of guests (e.g., adult friend); another example context tier could be associated with a playback session for the user in presence of older child(ren); another example context tier could be associated with a playback session for the user in presence of young child(ren); etc. In this way, content can be recommended appropriately based on the type of users that could potentially be exposed to the media content.

### Recommendation System

Media content recommendations can be provided by a recommendation system. The recommendation system can include one or more recommendation engines trained to provide media content recommendations based on a sample/reference set of media items and/or any other data. For example, the recommendation engines could be trained to provide recommendations on media content that is similar to the sample media content. Media content can be similar in multiple ways, for example media content with similar and/or common characteristics, similar and/or common attributes, similar and/or common metadata etc. (e.g., similar or common name, topic, artist, genre, tempo, age rating, etc.).

The sample media content could be obtained from user playback history. In this way, future content recommendations can be related to content that the user has played back before and therefore may potentially enjoy. In some instances, the context in which the user plays back media content could be taken into consideration to train the recommendation system. For example, if the user consumes a particular type of content when the user is alone, such type of content could be associated with a private context (e.g., as part of a private preferences profile). In this way, this content could be used as a sample for the recommendation system to provide recommendations for a private context.

In some instances, the recommendation system can be at least partially configured based on user input and/or preferences. For example, a user may be able to indicate media content for each context, or media content that should not be considered for recommendations for some context. As another example, the user may be able to indicate sample media content for each context. Example techniques for Media Content Curation Based on Sample Media Item(s) are described in U.S. Provisional Patent Application Ser. No. 63/523,754 filed on Jun. 28, 2023 and entitled “MEDIA CONTENT CURATION BASED ON SAMPLE MEDIA ITEM(S),” which application is expressly incorporated herein by reference in its entirety. In some instances, the user could flag a particular artist as “private only” so that this artist (and potentially similar artists) is not recommended and/or played back in a shared playback context. These preferences can be set at any time by the user. For example, if a media item is recommended/played back and the user finds the media item inappropriate for the current content, the user could flag (e.g., via a user interface) the media content as inappropriate for the current context and/or select a context to be associated with the media item. The recommendation engine could be trained and re-trained accordingly.

The recommendation system can be configured to apply weights to the sample media items in the playback history based on various factors. For example, weights can be applied based on user's preferences and/or customizations such that content recommendations are more strongly directed to the user's interests. In some instances, weights can be applied based on the context. For example, media items in a playback history associated with a private context could have lesser weight when/if used as a sample for shared context recommendations. Other data could be used to apply weights to sample media items for recommendation, for example additional context data could be used to further curate a recommendation so that not only it is appropriate for the private/shared context, but also for the location, activity, time of the day, etc.

In some instances, the playback context is assessed when the user explicitly selects media content for playback (rather than or in addition to when content is automatically played back based on recommendations). The media content explicitly selected by the user could be associated with the detected context and used as sample media content for future recommendations for this same type of context. In this way, future content recommendations can be based on sample media items that the user has explicitly played back in the given context.

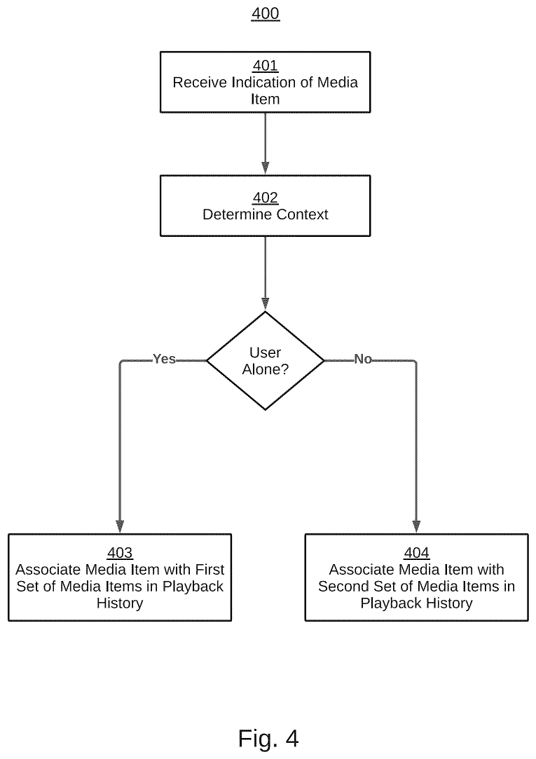

FIG. 4 includes a flowchart 400 for a set of methods of associating media content based on context. Method 400 could be used to define sample sets of media items to be used as reference for different contexts. Flowchart 400 includes a block 401 of receiving an indication of media content. The indication in block 401 could be received based on a user selection and/or request of media content for playback. The indication could be received from the user at any other time, for example during a training process of providing sample media items for training the recommendation system. This process could include the user providing, via a user interface, media content to be associated with or dissociated from a particular context such as a shared context.

Flowchart 400 includes a block 402 of determining a context associated with the media content indicated in block 401. The context can be explicitly indicated by the user (e.g., during a training process) or determined in the same or a similar way as explained for block 201 of flowchart 200.

Flowchart 400 includes blocks 403 and 404 of associating the media content with respective contexts and/or respective media content sets corresponding to each context. For example, if a first media item is selected for playback by the user while the user is with other people, such media item could be stored in association with a shared context (e.g., as part of a set of data that can be used as a reference for shared content recommendations). These blocks could also include updating a corresponding preferences profile to account for the media item. In this way, each set of data can be refined for each context and the recommendation system optimized by using updated data and leveraging genuine user habits while in the given context.

In some instances, the recommendation system is operated via artificial intelligence and machine learning algorithms so that no human has access to user data. In this way, the user privacy can be maintained while at the same time providing valuable content recommendations.

### Screening Services:

In some instances, content curation based on the context can be conducted upon/after receiving media content/media content recommendation(s) from a content source such as a streaming service. For example, the user may start playback of media content from any media content source. This media content may be received by the user's media playback system and/or a computing system (e.g., server) associated with the user's media playback system. At this point, context determination can be performed to determine whether the media content should be played back according to the given context. The received content can be “screened” and/or “vetted” before it is played back, to determine whether it is suitable for the current context.

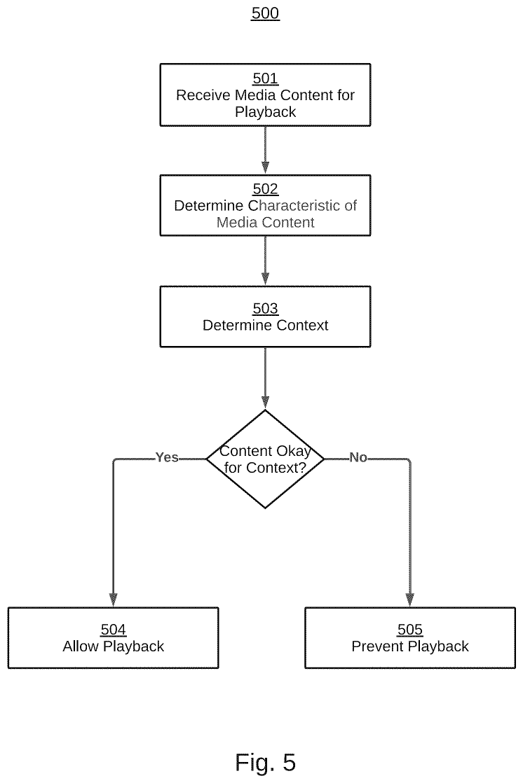

FIG. 5 illustrates a flowchart 500 for a set of methods of providing media content for playback according to the playback context. Flowchart 500 includes a block 501 of receiving an indication of a particular media item to be played back by a playback device of a media playback system. The indication could be received from a streaming service. The indication could include a command to play back the media item. The indication could include the media item itself. The indication could include a pointer (e.g., URL) to the media item or data identifying the media item such as media item name or location.

Flowchart 500 includes a block 502 of determining at least one characteristic of the media item. The characteristic can include any of the characteristics, attributes and/or metadata described before in this disclosure. For example, the characteristic can include an artist, a genre, a type of content, an age restriction, etc. The characteristic could also include description of the media item such as whether it includes explicit content, violence, profanity, etc.

Flowchart 500 includes a block 503 of determining a context in which the media item is to be played back. This block could be the same or similar to block 201 of flowchart 200. At this point, a set of media items associated with the determined context could be analyzed to determine similarities/differences with the media item received for playback. If the media item received for playback is among the media items associated with the given context or is similar, then it can be inferred that the media item is appropriate for the given context. Otherwise, the media content may not be appropriate.

Flowchart 500 includes a block 504 of allowing the playback device to play back the media item. This block could be performed based on the characteristic determined in block 502 and on a determination that the context is appropriate for the media item to be played back. For example, the characteristic may indicate that the media item is by an artist that the user listens to in private. If the context determination indicates that the user is listening to the media content alone, then the media item can be played back. Flowchart 500 also includes a block 505 of preventing the playback device from playing back the media item. This block could be performed based on the characteristic determined in block 502 and on a determination that the context may not be appropriate for the media item to be played back. For example, if the characteristic indicates that the media item is by an artist that the user listens to in private but the context determination indicates that the user is not alone, the media content should not be played back. At this point, the service could provide an indication so that another media item is obtained from the content source (e.g., the next media item in the queue or an additional recommendation). The process 500 can be repeated for any number of subsequent media items.

In this way, even if the content source (e.g., the streaming service) does not have knowledge of the context, the media playback system or other intermediary service could curate the content so that content that is actually played back is accurate for the context, regardless of the content that is actually being recommended by the streaming service.

In other instances, context data could be shared with the content sources (e.g., streaming services) so that the content source can determine appropriate media content to be recommended based on the context. In some instances, method 200 could be performed entirely by a content source. For example, the content source could receive context data from devices in the playback environment (e.g., from the media playback system), proceed to make the determination in block 201 based on the received context data, and provide the corresponding recommendations in blocks 202 and 203.

For example, a computing system could store a playback history of media items played back via a media playback service account. The computing system could receive a context indication indicating a context in which media content is to be played back by a user of the media playback account. This context information could be received from a media playback system and/or any other device. Based on a determination that the context indication corresponds to a first type of context (e.g., a private context), the computing system can provide one or more first content recommendations and based on a determination that the context indication corresponds to a second type of context (e.g., a shared context), the computing system could provide one or more second content recommendations. As explained before, the one or more first content recommendations can be based on the playback history and the one or more second content recommendation can be based on a portion of the playback history comprising a subset of media items played back, wherein the subset of media items excludes at least one media item of the playback history. The excluded media item(s) can be media items that the user wished to keep from sharing with other users.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A computing system comprising:
at least one processor; and
at least one non-transitory computer-readable medium comprising program instructions that are executable by the at least one processor such that the computing system is configured to:
determine a context in which media content is to be played back by a user of a media playback service account, wherein the context comprises one of: (i) a personal context in which media content is provided to the user alone; or (ii) a shared context in which media content is provided to the user in presence of at least one additional user; and
provide at least one media content recommendation based on the determined context and based on a playback history comprising media items previously played back via the media playback service account;
wherein:
for the personal context, the at least one media content recommendation is based on a first set of media items in the playback history; and
for the shared context, the at least one media content recommendation is based on a second set of media items in the playback history, wherein the second set of media items excludes at least one media item included in the first set of media items.

2. The computing system of claim 1, wherein determining the context comprises detecting a presence of one or more user devices within a proximity of at least one device via which media content is to be played back.

3. The computing system of claim 1, wherein determining the context comprises determining a characteristic of one or more devices via which media content is to be played back.

4. The computing system of claim 1, wherein determining the context comprises determining a characteristic of at least one room in which media content is to be played back.

5. The computing system of claim 1, wherein determining the context comprises determining an activity that the user is about to perform.

6. The computing system of claim 1, wherein providing the at least one media content recommendation comprises playing back, via at least one playback device associated with the media playback service account, at least one media item corresponding to the at least one media content recommendation.

7. The computing system of claim 1, wherein providing the at least one media content recommendation comprises displaying, via a graphical display associated with the media playback service account, at least one graphical representation corresponding to the at least one media content recommendation.

8. The computing system of claim 1, wherein:
the first set of media items comprises any one or more of the media items in the playback history; and
the second set of media items comprises any one or more of a subset of media items in the playback history, wherein the subset of media items excludes at least one media item in the playback history.

9. The computing system of claim 1, wherein the first set of media items comprises the second set of media items.

10. The computing system of claim 1, wherein:
the first set of media items corresponds to a first preferences profile associated with the media playback service account; and
the second set of media items corresponds to a second preferences profile associated with the media playback service account.

11. The computing system of claim 1, wherein:
the first set of media items corresponds to media items associated with a first playback mode available to the media playback service account; and
the second set of media items corresponds to media items associated with a second playback mode available to the media playback service account.

12. The computing system of claim 11, wherein:
the first playback mode corresponds to a private playback mode; and
the second playback mode corresponds to a shared playback mode.

13. The computing system of claim 1, wherein:
determining the context comprises determining the context via a computing system associated with the media playback service account; and
providing the at least one media content recommendation comprises providing the at least one media content via the computing system.

14. The computing system of claim 1, wherein:
determining the context comprises determining the context via a first computing system associated with the media playback service account; and
providing the at least one media content recommendation comprises providing the at least one media content via a second computing system associated with the media playback service account, wherein the first computing system is different and independent from the second computing system.

15. The computing system of claim 1, wherein:
determining the context comprises determining the context via a media playback system associated with the media playback service account; and
providing the at least one media content recommendation comprises providing the at least one media content via a streaming service associated with the media playback system.

16. The computing system of claim 15, wherein determining the context comprises the streaming service receiving, from the media playback system, context data corresponding to the context.

17. The computing system of claim 1, wherein determining the context comprises determining the context via one or more devices of a media playback system associated with the media playback account.

18. The computing system of claim 17, wherein the one or more devices comprise one or more of: a controller device of the media playback system, a playback device of the media playback system, or a server associated with the media playback system.

19. A computer-implemented method comprising:
determining a context in which media content is to be played back by a user of a media playback service account, wherein the context comprises one of: (i) a personal context in which media content is provided to the user alone; or (ii) a shared context in which media content is provided to the user in presence of at least one additional user; and
providing at least one media content recommendation based on the determined context and based on a playback history comprising media items previously played back via the media playback service account;
wherein:
for the personal context, the at least one media content recommendation is based on a first set of media items in the playback history; and
for the shared context, the at least one media content recommendation is based on a second set of media items in the playback history, wherein the second set of media items excludes at least one media item included in the first set of media items.

20. A computer-readable media comprising one or more non-transitory computer-readable storage media having stored thereon computer-executable instructions that, when executed at a processor, cause a computer system to perform a method for contextual media content recommendations, the method comprising:
determining a context in which media content is to be played back by a user of a media playback service account, wherein the context comprises one of: (i) a personal context in which media content is provided to the user alone; or (ii) a shared context in which media content is provided to the user in presence of at least one additional user; and
providing at least one media content recommendation based on the determined context and based on a playback history comprising media items previously played back via the media playback service account;
wherein:
for the personal context, the at least one media content recommendation is based on a first set of media items in the playback history; and
for the shared context, the at least one media content recommendation is based on a second set of media items in the playback history, wherein the second set of media items excludes at least one media item included in the first set of media items.
